(19) United States
(12) Patent Application Publication
(10) Pub. No.: US 2014/0129476 A1
(43) Pub. Date: May 8, 2014

(54) System and Method for Exchanging Business Leads

(71) Applicant: Troy Martin Smith, Wenatchee, WA (US)

(72) Inventor: Troy Martin Smith, Wenatchee, WA (US)

(21) Appl. No.: 13/671,403

(22) Filed: Nov. 7, 2012

(51) Int. Cl. G06Q 10/00

(52) U.S. Cl. 705/345

(57) ABSTRACT

A method and apparatus to exchange leads using a computer is disclosed. A server receives information relating to a first customer of the first user that is a potential customer for a second user and provides the first user with a customer credit. The server transmits to the second user a portion of the information relating to the potential customer and receives an indication from second user of acceptance of the portion of the information relating to the customer by the second user. If the second user has a customer credit in its account, additional information relating to the potential customer is transferred to the second user.

### TECHNICAL FIELD

These claimed embodiments relate to exchanging business leads and more particularly to a system and a method for managing the exchange of business leads based on a credit balance or acceptability of the exchanged lead.

### BACKGROUND OF THE INVENTION

A method and apparatus for exchanging business leads is disclosed.

Once source of leads for sales professionals are contacts from other sales professionals. Sales professionals in a particular field may typically attend networking functions where they meet other sales professionals in another field, and through these functions obtain leads. However, sometimes one professional may supply leads to other professionals without obtaining having a reciprocal amount of leads be returned.

The concern is also substantiated by a sales professional receiving a quantity of leads but the quality of the leads not always being up to the recipient's standard. Further the professional may receive the lead without having sufficient details resulting in the professional spending time or resources to turn the lead to no avail.

### SUMMARY OF THE INVENTION

In one implementation a method is disclosed to manage leads with a server computing device. The method includes receiving, from a first user of a first computing device via a network, information relating to a customer of the first user that is a potential customer for a second user. In response to a request received from the second user via the second computing device, a portion of the information relating to the customer is transmitted via the network to a second computing device. An indication is received from second user via the second computing device of acceptance of the portion of the information relating to the customer by the second user. A determination is made if the second user has a credit balance due to a prior transfer by the second user of one or more additional potential customers to the server computing device. If the second user has the credit balance, additional information relating to the customer is transferred to the second user via the second computing device.

In another implementation, a system is disclosed including a server computing device that includes a receiver that receives from a first user of a first computing device via a network information relating to a customer of the first user that is a potential customer for a second user; a transmitter to transmit via the network to a second computing device, in response to a request received from the second user via the second computing device, a portion of the information relating to the customer; the receiver receives an indication, from second user via the second computing device, of acceptance of the portion of the information relating to the customer by the second user; a controller to determine if the second user has a credit balance due to a prior transfer by the second user of one or more additional potential customers to the server computing device, and if the second user has the credit balance, the controller feeds additional information relating to the customer to the transmitter to transfer the additional information to the second user via the second computing device.

In addition, a non-transitory computer readable storage medium that includes instructions is disclosed. The instructions when executed by a processor receives, from a first user of a first computing device via a network, information relating to a customer of the first user that is a potential customer for a second user; transmits via the network to a second computing device, in response to a request received from the second user via the second computing device, a portion of the information relating to the customer; receives an indication, from second user via the second computing device, of acceptance of the portion of the information relating to the customer by the second user; transfers additional information relating to the customer to the second user via the second computing device; and receives an indication of acceptability, from second user via the second computing device, regarding the information relating to the potential customer for the second user.

In one or more various aspects, means, devices and modules (as disclosed herein) include but are not limited to circuitry and/or programming for effecting the herein referenced functional aspects; the circuitry and/or programming can be virtually any combination of hardware, software, and/or firmware configured to effect the herein referenced functional aspects depending upon the design choices of the system designer. In addition to the foregoing, other system aspects means are described in the claims, drawings, and/or text forming a part of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a system diagram of a system for exchanging leads in accordance with one implementation of the invention;

FIG. 2 is a simplified schematic diagram of client computing device used in the system for exchanging leads;

FIG. 3 is a simplified schematic diagram of server computing device used in the system for exchanging leads;

FIGS. 4 and 5 are flow charts illustrating the process for exchanging leads by the lead exchanging system shown in FIG. 1; and

FIGS. 6-8 are exemplary screen diagrams displayed on computer screen of a sales professional shown in FIG. 1 that are received from the server computer implementing the process illustrated in FIGS. 4 and 5.

### DETAILED DESCRIPTION

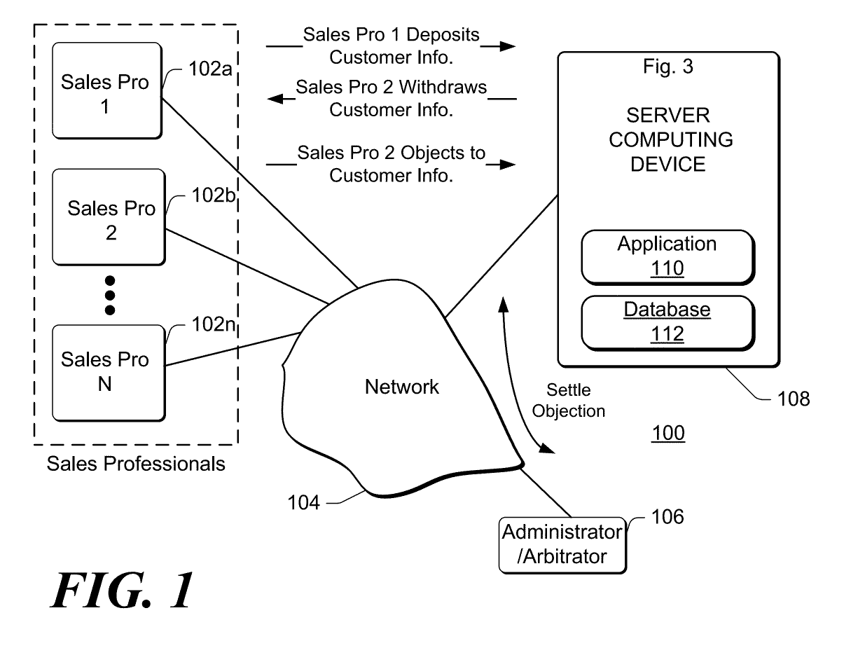

Referring to FIG. 1 there is shown a system 100 for exchanging leads. System 100 includes end user (clients or Sales Professionals) computing devices (also referred to herein as “personal computing devices”) 102a-102b coupled via a network 104 to administrator/arbitrator computing device 106 and to one or more network server devices 108. Server computing device 108 is described communicating directly with computing devices 102a-102b and client computing device 106; however, such communication is for illustration purposes only and in a typical implementation server computing device 108 communicates via network 104 to sales professionals computing devices 102(a-n), other end user computing devices (not shown) and administrator computing device 106.

Server computing device 108 may be a network computer, host computer, network server, web server, email server or any computing device for hosting email communications applications and systems, one example of which includes a Microsoft® exchange server. Although sales professional computing devices 102 and administrator computing device are described herein as a personal computing device, devices 102 and client computing device 106 may be any type of computing device such as a cell phone, smart phone, laptop, tablet, mobile computer, desktop computer, personal computer, PDA, music player or game player device.

In one implementation, server computing device 108 includes one or more processors (not shown) and computer memory containing an application 110 and database 112. Application 100 generates web pages that are fed to sales professionals operating computing devices 102a-102n and administrator operating computing device 106. Web pages, in one implementation, may be defined as one or more pages of information necessary to enable a sale professional to enter and receive information for use in depositing and obtaining sales leads. Server computing device 108 includes a software application 110 which when executed by the processors, transmit and receive information from sales professionals operating computing devices 102a-n and an arbitrator/administrator operating computing device 106.

Referring to FIG. 1, during operation the user or sales professional operating one of the computing devices 102a-n periodically using an I/O device provides a signal to server computing device 108. The signal provides a request for the server computing device 108 to send client computing device 102a a web page stored in memory of server computing device 108. The web page enable the sales professional operating one of computing devices 102a-n to enter and deposit information regarding a customer of the sale professional that could be a potential customer for a second sales professional (also referred to herein as a “lead”).

A second client professional operating computing device 102a request and receives web pages from server computing device via network 104 that enables the second client professional operating computing device 102b to withdraw the potential customer information deposited by the first sales profession.

The second client professional receives a portion of the customer information and if the second client professional like the portion of the customer information, the second client professional sends a request to the server computing device 108 to provide all of the potential customer information (including customer identifying information). Upon the request from the second client professional, the server computing device determines whether the second client professional has a credit balance in the professionals account due to a deposit by the second client professional of potential customer information. If the second client professional has a credit balance, the server computing device 108 transmits the additional potential customer information (including customer identifying information) to the second client professional via one of computing devices 102a-n. The server computing device 108 then lock out other sales professionals from receiving the potential customer information provided to the second client professional. Although only two end user computer devices 102a-102n, are described, the server computing device 108 may receive requests and leads, and send customer information any number of end user computing devices or to any device on the internet, a company intranet or the World Wide Web.

Upon receiving the lead, e.g. identification information regarding the potential customer, the second sales professional may object to the quality of the lead. The server computing device may then provide the first sales professional to object to the second sales professional objection. The server computing device in response to the first sales professionals object, send the information regarding the potential client and the objects to the administrator/arbitrator 106. The administrator/arbitrator then determines which sales professional's objection is valid. In response to the decision by the administrator/arbitrator the server computing device 108 takes corrective action, such as by debiting credits from one the sales professional's account.

### Example Personal Computing Device Architecture

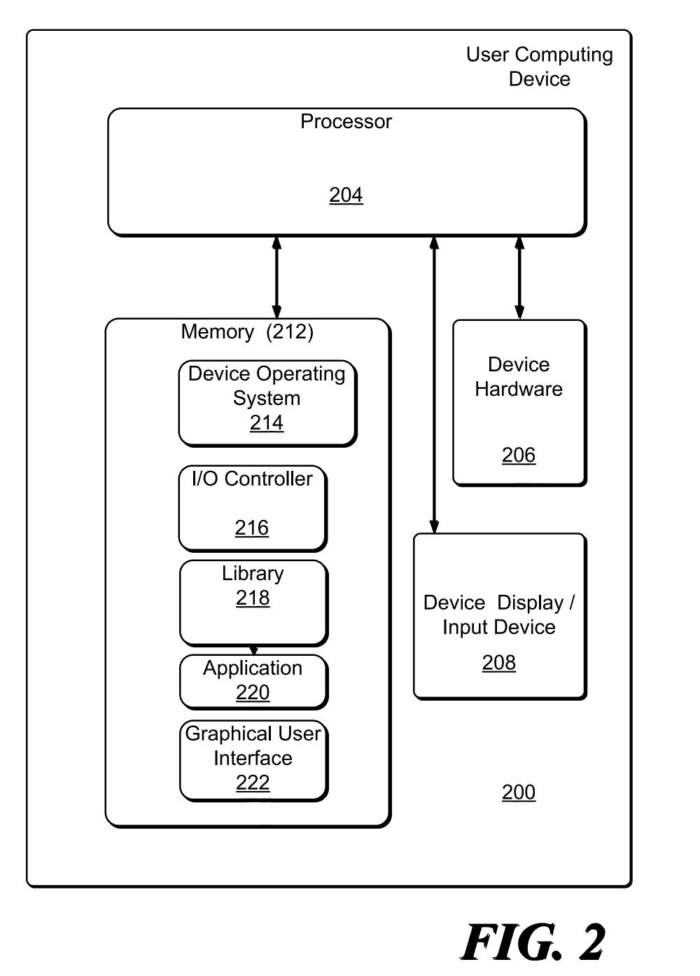

In FIG. 2 there are illustrated selected modules in Personal Computing Device 200 (computing device 102a-b and 106 of FIG. 1). Personal computing device 200 includes a processing device 204, memory 212, hardware 206 and display/input device 208. Processing device 204 may include a microprocessor, microcontroller or any such device for accessing memory 212, hardware 206 and display/input device 208. Processing device 204 has processing capabilities and memory suitable to store and execute computer-executable instructions. In one example, Processor 204 includes one or more processors 204.

Processing device 204 executes instructions stored in memory 212, and in response thereto, processes signals from hardware 206 and display/input device 208. Hardware 206 may include network and communication circuitry for communicating with network 104 (FIG. 1). Display/Input device 208 receives inputs from a user of the personal computing device and may include a keyboard, mouse, track pad, microphone, audio input device, video input device, or touch screen display. Display device 208 may include an LED, LCD, CRT or any type of display device.

Memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium (including a non-transitory computer readable storage medium) which can be used to store the desired information and which can be accessed by a computer system.

Modules stored in memory 212 of the personal computing device 200 may include an operating system 214, an I/O controller 216, a library 218, a browser application 220 and a graphical user interface 222. Operating system 214 may be used by application 220 to operate device 200. I/O controller may provide drivers for device 200 to communicate with hardware 206 or device 208. Library 218 may include preconfigured parameters (or set by the user before or after initial operation) such as personal computing device operating parameters and configurations. Browser application may include a generally known network browser (including, but not limited to, Internet Explorer, Netscape Firefox, Oracle, Chrome or Safari) for displaying articles manifested as web pages received from the network 106.

### Example Architecture

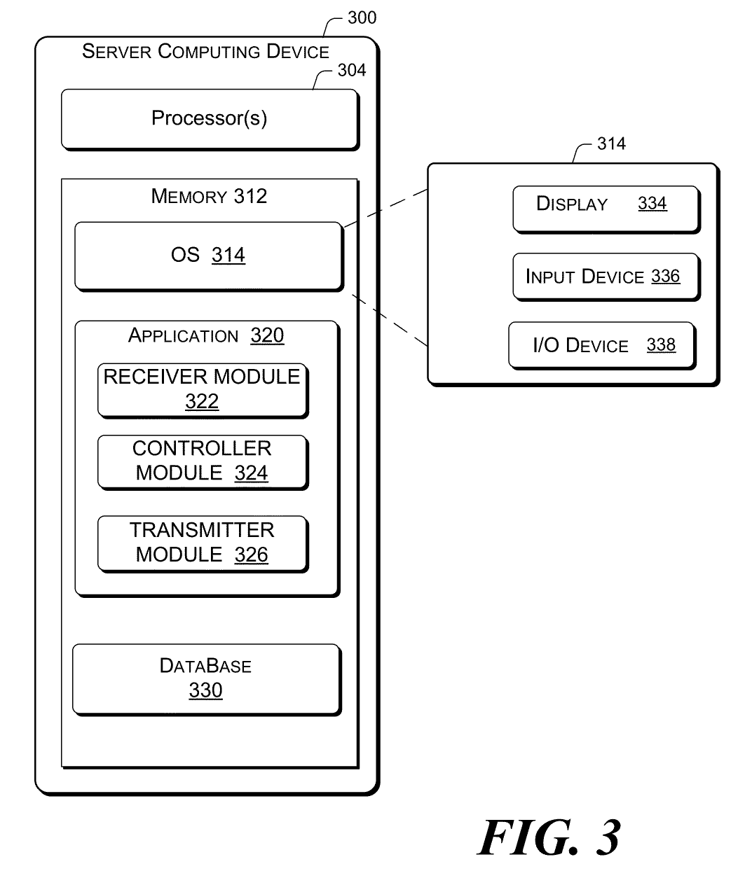

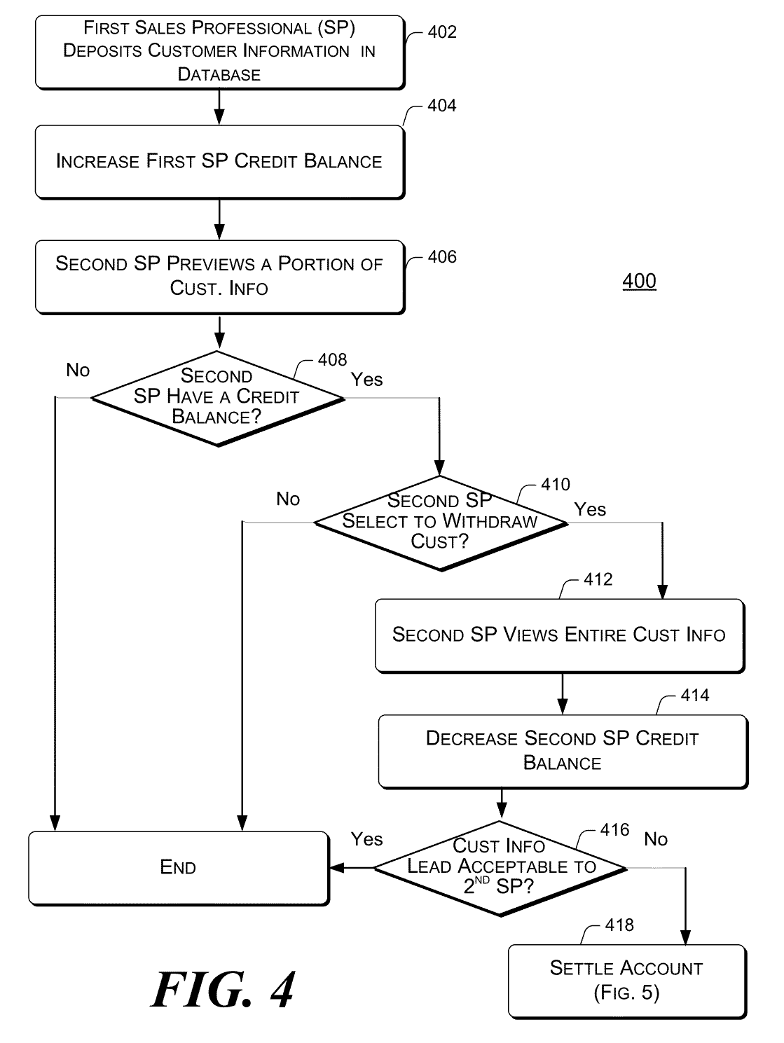

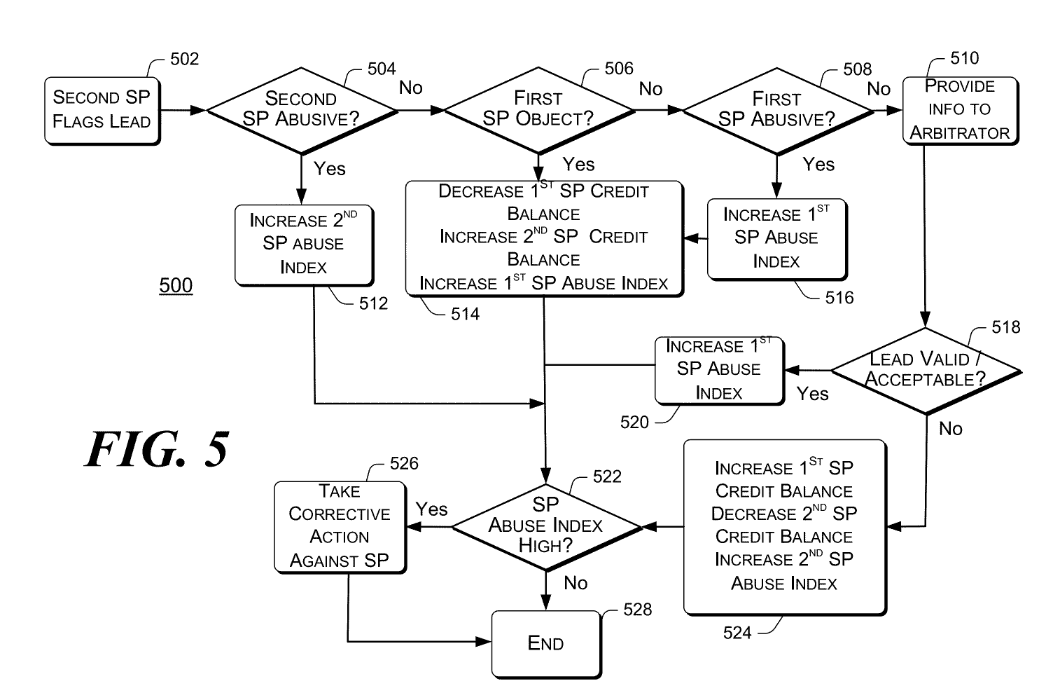

In FIG. 3 there are illustrated selected modules in host computing device 300 (Server Computing Device 108 of FIG. 1) using processes 400 and 500 shown in FIGS. 4 and 5. Hosting device 300 includes a processing device 304, memory 312, and hardware 314. Processing device 304 may include one or more a microprocessors, microcontrollers or any such devices for accessing memory 312 or hardware 314. Processing device 304 has processing capabilities and memory 312 suitable to store and execute computer-executable instructions.

Processing device 304 executes instruction stored in memory 312, and in response thereto, processes signals from hardware 314. Hardware 314 may include a display 334, and input device 336 and an I/O device 338. I/O device 338 may include a network and communication circuitry for communicating with network 104. Input device 336 receives inputs from a user of the host computing device 300 and may include a keyboard, mouse, track pad, microphone, audio input device, video input device, or touch screen display. Display device 334 may include an LED, LCD, CRT or any type of display device.

Memory 312 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 312 of the hosting device 300 may include an operating system 314, application 320 and a library of other applications such as a database 330. Operating system 314 may be used by application 320 to operate device 300. The operating system 314 may include drivers for device 300 to communicate with I/O device 336. Database 330 may include preconfigured parameters (or set by the user before or after initial operation) such web site operating parameters, web site libraries, list of client/leads, forms to be completed by the sales professionals. Also stored in the database 330 in memory 312 may be the leads of potential customers and a statement of accounts for the sales professionals. The leads and accounts may be supplied as web pages.

Application 320 includes a receiver module 322, a controller module 324, and a transmitter module 326 (also referred to as a controller, receiver and a transmitter).

Receiver module 322 includes software instruction, that when executed by processor 304 receive via the network lead requests from the sales professionals. In addition, instructions in receiver module 322 enable the reception from the first sales professional of a first computing device 102a via a network, information relating to a customer of the first sales professional that could be a potential customer for a second sales professional. The receiver module 222 may also include instructions to receive an indication, from the second sales professional via the second computing device 102b, of acceptance of the portion of the information relating to the customer by the second sales professional. The receiver may further include instructions to receive an indication of acceptability, from second sales professional via the second computing device 102b, regarding the information relating to the potential customer for the second sales professional.

Transmitter module 326 includes software instructions, that when executed by processor 304 transmit the leads and the web pages to multiple sales professionals. In one implementation transmitter module 226 transmits via the network to the second computing device 102b, in response to a request received from the second sales professional via the second computing device 102b, a portion of the information relating to the customer from memory 312 of the computing device 300.

In an additional implementation, the controller module 324 determines if the second sales professional has a credit balance due to a prior transfer by the second sales professional of one or more additional potential customers to the server computing device. If the second sales professional has the credit balance, the controller module 224 feeds additional information relating to the customer to the transmitter module 226 to transfer the additional information to the second sales professional via the second computing device 102b.

The controller module may include instructions to increase and decrease credit balance of the sales professional. Specifically the controller module 224 increases a credit balance of the first sales professional in response to receipt of information relating to a customer of the first sales professional that is a potential customer for the second sales professional. The controller module 226 decreases a credit balance of the second sales professional in response to the transferring of additional information relating to the customer to the second sales professional via the second computing device 102b.

The controller module 224 can track whether one of the sales professionals is abusive and take corrective action. For example if the indication of acceptability indicates that the information relating to the potential customer for the second sales professional is not acceptable to the second sales professional, the controller module 224 includes instructions to determine whether the second sales professional is abusive. The controller module 224 in response to the determination the second sales professional is abusive, may increase an abuse index relating to the second sales professional. If in response to the determination the controller module 226 determines the second sales professional is not abusive, the controller module 226 triggers the transmitter module 226 to send an indication to the first sales professional that the second sales professional has objected to the information relating to the potential customer for the second sales professional. The controller module 224 may determine if the first computing device 102a has providing an indication that the first sales professional has not objected to the second sales professional's objection, and the controller module 224 in response to the indication that the first sales professional has not objected, decreases the credit balance of the first sales professional, increases the credit balance of the second sales professional and increases an abuse index of the first sales professional.

Illustrated in FIGS. 4 and 5, are processes 400 and 500 for exchanging leads. The exemplary process in FIGS. 4 and 5 are illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIGS. 4 and 5, although it may be implemented in other system architectures.

Referring to FIGS. 4 and 5, a flowchart of process 400 and 500 performed by processor 304 when executing the software instructions in application 320 is shown. Process 400 includes blocks 402-420, and process 500 includes blocks 502-528. When application 320 is executed on the computing device 300, it uses the processor 304 and instructions in modules 322-326 that are shown in FIG. 3.

In the process 400, the server computing device 300 (FIG. 3) stores leads received from sales professionals, and provides one or more leads to sales professional computing devices 102a-102n upon request from the sales professionals operating computing devices 102a-102n via network 104. These requests may be received by server 108 as digital signals that include sales professional identification code, a requested lead identifiers, selection indications and web addresses.

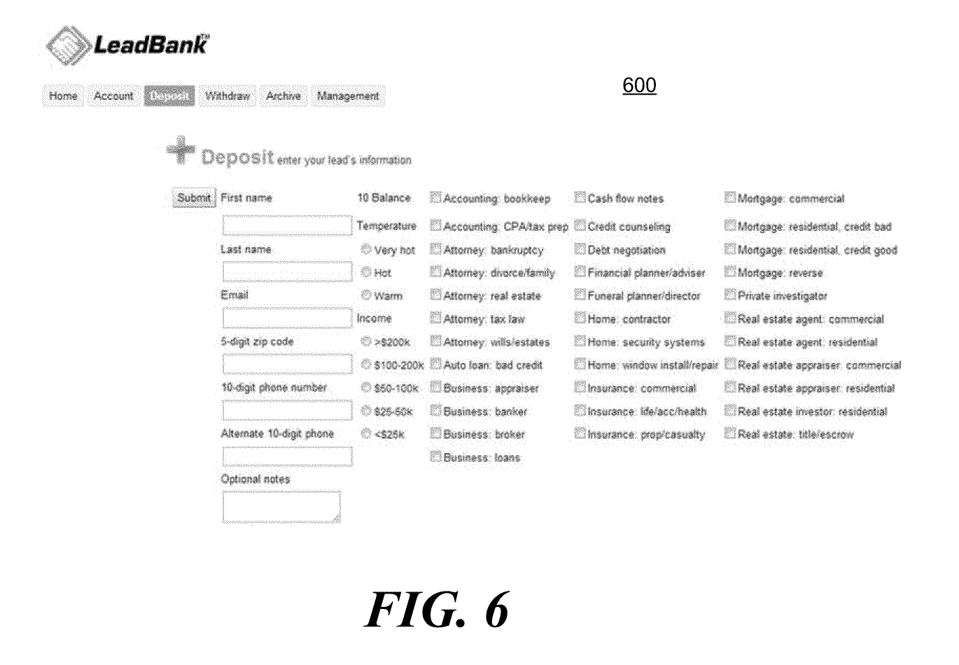

In block 402, computing device 300 feeds via network 104 a form/web page to a first sales profession operating one of computing devices 102a-102n. Computing device 300 receives customer information from the first sales professional. Computing device 300 stores the received potential customer information in a database. Such customer information may include the name of the lead/customer, one or more categories of the customer/lead, lead quality (e.g. the lead quality based on the feedback rating/quality score/abuse index of the referring user) a geography/location of the customer/lead, a temperature rating of the customer/lead (e.g. a number value indicating the likelihood of the customer/lead needing a sales professional where such rating may also be based on the type of product of the customer/lead); and an income category of customer/lead (e.g. what is the Gross income of the lead/customer). Exemplary categories of the customer/lead may include Attorneys, Car loan personnel, business brokers, funeral personnel, and credit counselors. An exemplary web page 500 with exemplary customer information to be completed by a sales professional when depositing a lead is shown in FIG. 6.

In block 404, computing device 300 increases a credit balance of a previously opened account of the first sales profession. In one implementation, the credit balance is increased by a credit for every potential customer or lead that the first sales profession submitted. The account balance may be reviewed by the sales profession at any time using a web page supplied by computing device 300.

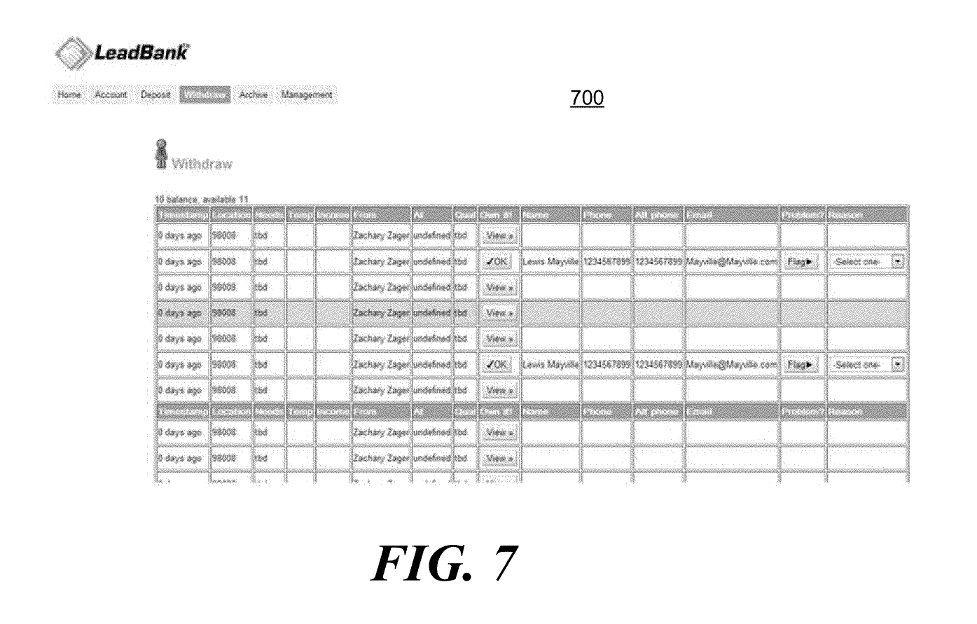

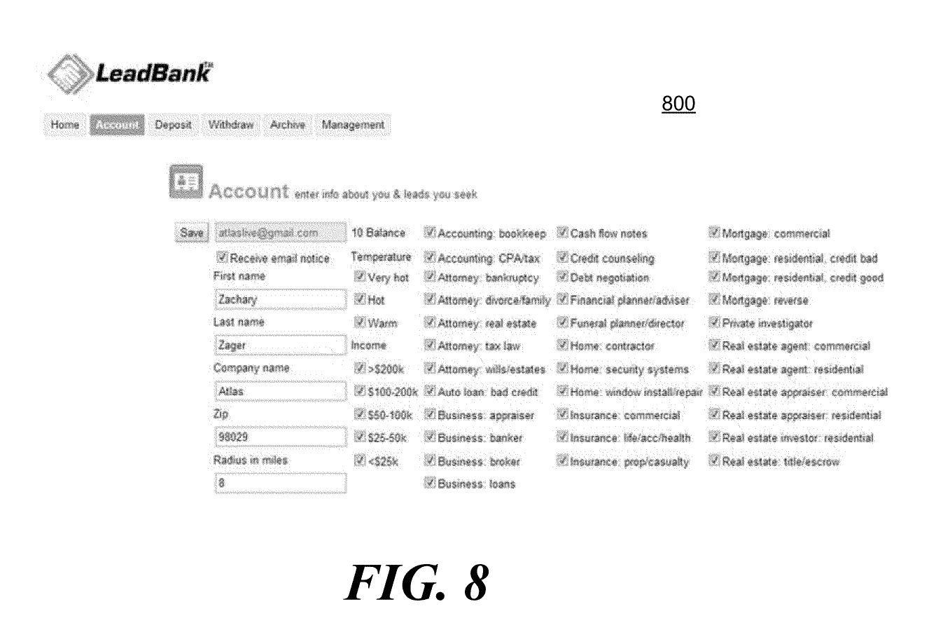

In block 406, a second sales professional accesses additional web page 700 and page 800 (See FIG. 7 and FIG. 8) supplied by computing device 300. Web page 700 enables the second sales professional to preview a portion of the customer information supplied the first sales professional. Web page 800 enables the second sales professional to enter preferences on the types of leads/customers the second sales professional seeks. Although the specification discusses a first sales professional supplying a customer lead, and a second sales professional accessing the lead, any sales professional (e.g. a third sales professional) may supply the lead, and any other sales professional (e.g. the second or a forth sales professional) may retrieve the lead. During the preview process the second sales professional may only view key elements of lead, e.g. the leads location, temperature, income level and/or category, but may not see the leads name or other customer identifying information. In response to the second sales professional completing form 800 and requesting to preview leads, computing device 300 filters the available leads based on the second sales professional requirements and provides a preview of the filtered available leads to the second sales professional. The leads may also be provided to the user in a ranked by category selected by the sales professional. The second sales professional may request further information from computing device 300 so that the second sales professional may identify the lead/customer (i.e. withdraw the lead).

In block 408, computing device 300 determine whether the second sales professional has a credit balance. If it does not have a balance, computing device 300 notifies the second sales professional that it does not have a lead credits, and the process ends.

If the second sales professional has a balance, in block 410, the computing device 300 determines if the second sales professional has selected to withdraw a lead/customer. If the second sales professional has not selected to withdraw a lead, the process ends.

If the second sales professional has selected to withdraw a lead/customer, in block 410 computing device 300 provides via the second computing device 102b the second sales professional the entire information contained in the requested lead, including the lead identifying information. Thus the second sales professional can view the entire lead. Further the computing device 300 locks down the lead so that the lead is no longer accessible to any other user/sales professional except the second sales professional (i.e. the sales professional that requested and was provided the entire lead).

In block 414, computing device 300 decreases the second sales professional credit balance.

In block 416 computing device 300 makes a determination if the customer information provided in the lead is acceptable to the second sales professional. This determination is made based on a notification by the second sales professional to computing device 300. If the second sales professional has not provided a indication that the customer/lead is not acceptable within a predetermined period of time then the process ends. If the second sales professional has notified computing device 300 that the customer/lead is not acceptable with the predetermined period of time a process to settle the account is initiated. Details of this process are described in connection with FIG. 5.

Referring to FIG. 5, in block 502 the server computing device 300 (FIG. 3) records that the second sales professional has flagged a lead provided by the first sales professional.

In block 504, the computing device determines if the second sales professionals is abusive by wrongfully flagging the lead. Such determination may be made by computing device 300 determining that the second sales professional has repeatedly flagged leads without any basis. If the computing device has determined that the second sales professional is abusive, an abuse index for the second sales professional is incremented in block 512.

If the computing device 300 does not determine that the second sales professional is abusive, in block 506 computing device 300 notifies the first sales professional of the flag to the lead and determines if the first sales professional has objected to the flag. If the first sales professional has objected to the flag, in block 514, the credit balance of the first sales professional is decreased, the credit balance of the second sales professional is increased and the abuse index for the first sales professional is increased.

If the computing device 300 determines that the second sales professional is abusive, in block 508 a determination is made as to whether the first sales professional is abusive. If the first sales professional is abusive, the abuse index of the first sales professional is increased in block 416, and block 514 is executed.

If the computing device 300 does not determine in block 508 that the second sales professional is abusive, in block 510 computing device 300 provides information regarding the lead being flagged to the administrator/arbitrator via computing device 106. Administrator/arbitrator determines whether the lead is valid/acceptable and notifies computing device 300 via computing device 106.

Computing device 300 in block 518 determines if the notification from the Administrator/arbitrator indicated that the lead was valid/acceptable. If the lead was valid/acceptable, computing device 300 increases the first sales professional abuse index in block 520. If the lead was not valid/acceptable, computing device 300 in block 524 increases the first sales professional credit balance, decreases the second sales professional credit balance and increases the second sales professional abuse index.

After executing block 412, 414, 420 or 424, computing device 300 in block 522 determines if the abuse index of the first or second sales professional has exceeded a predetermined limit. If it has, in block 526, computing device 300 may take corrective action against the abusive first or second sales professional. In one implementation, the computing device may delete the abusing sales professional's account and ban the abusing sales professional from the system. If there are no sales professional with an abusive balance exceeding a predetermined amount, the process ends in block 528.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

1. A method for managing leads with a server computing device, the method comprising:
receiving, from a first user of a first computing device via a network, information relating to a customer of the first user that is a potential customer for a second user;
transmitting via the network to a second computing device, in response to a request received from the second user via the second computing device, a portion of the information relating to the potential customer;
receiving an indication, from second user via the second computing device, of acceptance of the portion of the information relating to the potential customer by the second user;
determining if the second user has a credit balance due to a prior transfer by the second user of one or more additional potential customers to the server computing device; and
if the second user has the credit balance, transferring additional information relating to the potential customer to the second user via the second computing device.

2. The method as recited in claim 1, further comprising increasing a credit balance of the first user in response to receipt of information relating to a customer of the first user that is a potential customer for the second user.

3. The method as recited in claim 1, further comprising decreasing a credit balance of the second user in response to the transferring of additional information relating to the customer to the second user via the second computing device.

4. The method as recited in claim 1, further comprising:
receiving an indication of acceptability, from second user via the second computing device, regarding the information relating to the potential customer for the second user.

5. The method as recited in claim 4, further comprising:
if the indication of acceptability indicates that the information relating to the potential customer for the second user is not acceptable to the second user, determining whether the second user is abusive.

6. The method as recited in claim 5, wherein if in response to the determination the second use is abusive, increasing an abuse index relating to the second user.

7. The method as recited in claim 6, wherein if in response to the determination the second user is not abusive, sending an indication to the first user that the second user has objected to the information relating to the potential customer for the second user, and determining if the first computing device has providing an indication that the first user has not objected to the second users objection; in response to the indication that the first user has not objected, decreasing the credit balance of the first user, increasing the credit balance of the second user and increasing an abuse index of the first user.

8. A system comprising:
a server computing device including:
a receiver to receive, from a first user of a first computing device via a network, information relating to a customer of the first user that is a potential customer for a second user;
a transmitter to transmit via the network to a second computing device, in response to a request received from the second user via the second computing device, a portion of the information relating to the customer;
the receiver to receive an indication, from second user via the second computing device, of acceptance of the portion of the information relating to the customer by the second user;
a controller to determine if the second user has a credit balance due to a prior transfer by the second user of one or more additional potential customers to the server computing device, and if the second user has the credit balance, the controller feeding additional information relating to the customer to the transmitter to transfer the additional information to the second user via the second computing device.

9. The system as recited in claim 8 wherein the controller increases a credit balance of the first user in response to receipt of information relating to a customer of the first user that is a potential customer for the second user.

10. The system as recited in claim 8, wherein the controller decreases a credit balance of the second user in response to the transferring of additional information relating to the customer to the second user via the second computing device.

11. The system as recited in claim 8, wherein the receiver receives an indication of acceptability, from second user via the second computing device, regarding the information relating to the potential customer for the second user.

12. The system as recited in claim 11, wherein if the indication of acceptability indicates that the information relating to the potential customer for the second user is not acceptable to the second user, the controller determines whether the second user is abusive.

13. The system as recited in claim 12, wherein the controller in response to the determination the second user is abusive, increases an abuse index relating to the second user.

14. The system as recited in claim 13, wherein if in response to the determination the controller determines the second user is not abusive, the transmitter send an indication to the first user that the second user has objected to the information relating to the potential customer for the second user,
wherein the controller determines if the first computing device has providing an indication that the first user has not objected to the second users objection, and wherein the controller in response to the indication that the first user has not objected, decreases the credit balance of the first user, increases the credit balance of the second user and increases an abuse index of the first user.

15. A non-transitory computer readable storage medium comprising instructions which when executed by a processor comprises:
receiving, from a first user of a first computing device via a network, information relating to a customer of the first user that is a potential customer for a second user;
transmitting via the network to a second computing device, in response to a request received from the second user via the second computing device, a portion of the information relating to the customer;
receiving an indication, from second user via the second computing device, of acceptance of the portion of the information relating to the customer by the second user;
transferring additional information relating to the customer to the second user via the second computing device; and
receiving an indication of acceptability, from second user via the second computing device, regarding the information relating to the potential customer for the second user.

16. The computer readable storage medium as recited in claim 15, further comprising instructions which when executed by a processor comprises:
determining if the indication of acceptability indicates that the information relating to the potential customer for the second user is not acceptable to the second user.

17. The computer readable storage medium as recited in claim 16, further comprising instructions which when executed by a processor comprises:
determining whether the first user or the second user is abusive;
increasing an abuse index for the first user if the first user is abusive; and
increasing an abuse index for the second user if the second user is abusive.

18. The computer readable storage medium as recited in claim 16, further comprising instructions which when executed by a processor comprises:
sending an indication to the first user that the second user has objected to the information relating to the potential customer for the second user, and determining if the first computing device has providing an indication that the first user has not objected to the second users objection; and
in response to the indication that the first user has not objected, and decreasing the credit balance of the first user, increasing the credit balance of the second user.
